(19) United States
(12) Patent Application Publication
(10) Pub. No.: US 2014/0023757 A1
(43) Pub. Date: Jan. 23, 2014

(54) THERMAL PROCESSES OF REDUCING FOODBORNE PATHOGENS IN BAGGED FOOD PRODUCTS

(71) Applicant: Tyler S. Christensen, Pleasant View, UT (US)

(72) Inventor: Tyler S. Christensen, Pleasant View, UT (US)

(73) Assignee: Honeyville Grain, Inc., Rancho Cucamonga, CA (US)

(21) Appl. No.: 13/551,582

(22) Filed: Jul. 17, 2012

(51) Int. Cl. A23L 3/10; B23P 11/00

(52) U.S. Cl. 426/232; 29/428

(57) ABSTRACT

A heating assembly designed for reducing foodborne pathogens in bagged food products comprises a heat insulated treatment chamber, multiple high temperature natural gas fired furnaces, multiple insulated ductworks further comprising multiple sets of intake ducts and multiple sets of exhaust ducts, a cooling system that allows air to be controlled and supplied into the treatment chamber, multiple temperature sensor probes placed in the treatment chamber, the natural gas fired furnaces, and the bagged food products, a digital control system, and a computer program that monitors the temperature of each probe. A specially designed racking system with multiple levels allows multiple dry bags containing the food products to be stacked in a manner that rapidly and uniformly heat the food products.

### FIELD OF THE INVENTION

The present invention relates to thermal processes of reducing foodborne pathogens in bagged food products.

### BACKGROUND OF THE INVENTION

### Description of Prior Art and Related Information

Manufactured and processed food ingredients inherently contain foodborne pathogens that can cause foodborne illnesses. Some of the leading foodborne pathogens that cause illnesses are Escherichia coli (“E. coli”), Listeria monocytogenes, Salmonella, Staphylococcus aureus, yeast and mold, to name a few. Generally, low moisture food ingredients do not support the growth of microbial pathogens. Therefore, food ingredients in a dry state are usually considered to be microbiologically stable. However, foodborne pathogens can still persist for prolonged periods of time even in a dry state and in low moisture food ingredients. Moreover, further problem arises upon rehydration of the food ingredients, in which the potential for microbial growth is reinstated. If these contaminated food ingredients are incorporated further into subsequent processing of food products that do not employ additional steps to eliminate or reduce microbial growth—also known as “kill steps,” the foodborne pathogens may pose a significant health risk to the public.

As food manufacturers and processors become more aware of the dangers of foodborne pathogens, there has been a growing demand in the food processing industry for a way to reduce or eliminate pathogens from food ingredients where there is no verifiable kill step in the subsequent food production process. In response, the U.S. Food and Drug Administration (“FDA”) established certain procedures for food manufacturers and processors to follow in an effort to prevent, reduce or eliminate the amount of pathogens contained in food ingredients.

It is generally suggested that a tolerable level of risk may be achieved by demonstrating a “5-log reduction” in foodborne pathogens. A “log reduction” is a mathematical term used in the industry to show the relative number of live microbial organisms that are eliminated from the food ingredients. In a 5-log reduction, the number of live pathogens is reduced by 100,000 fold. This is better understood by the following examples:
If a food ingredient contains 10 pathogens, a “1 log reduction” would reduce the number of pathogens to 1.
If a food ingredient contains 100 pathogens, a “2 log reduction” would reduce the number of pathogens to 1.
If a food ingredient contains 1000 pathogens, a “3 log reduction” would reduce the number of pathogens to 1.
If a food ingredient contains 10,000 pathogens, a “4 log reduction” would reduce the number of pathogens to 1.
If a food ingredient contains 100,000 pathogens, a “5 log reduction” would reduce the number of pathogens to 1.
If a food ingredient contains 1,000,000 pathogens, a “6 log reduction” would reduce the number of pathogens to 1.

Currently, a 5-log pathogen reduction for food ingredients is the guideline that is recommended by the FDA. Through its Hazard Analysis and Critical Control Point (“HACCP”) Systems, the FDA encourages food manufacturers and processors to consistently perform 5-log reduction treatments on food ingredients based upon the FDA's guidance and current scientific understanding.

Several methods are currently used in an effort to reduce or eliminate live foodborne pathogens from food ingredients. For example, one method currently known in the art uses a process in which food products to be treated are stacked on pallets and heated by a furnace heat source. There are several problems associated with this method. First, because the food products are left in palletized form, the food products are not uniformly heated and it takes a much longer time for the products to reach the necessary temperature to neutralize the pathogens. Second, the method does not have the necessary monitoring and temperature recording system to ensure that all food products are uniformly heated to reach the proper temperature and time interval that ensures a 5-log reduction. Therefore, there is nothing in this method that validates the effectiveness or consistency of the process. Further, this method does not have a closed air furnace system, and instead allows air to come into contact with the furnace heat source, leaving the products exposed to combustion by elements that can taint and damage the products.

Another method currently known in the art uses ethylene oxide gas to penetrate the product and reduce or eliminate foodborne pathogens. However, there has not been enough research done by the food industry on this method to understand its effects on the treated food products, and the FDA does not have enough scientific understanding of this treatment to confirm its safety as to date. Consequently, the FDA has not approved this process for foods intended for human consumption.

The object of the present invention is to provide a closed-system process to heat food ingredients to a sufficient temperature that consistently and verifiably produces a 5-log reduction in food pathogens, particularly when no other kill step is used or present, wherein the process is gentle enough as to maintain the molecular structure of the product.

### SUMMARY OF THE INVENTION

The present invention provides devices and methods of applying thermal treatment to bagged food products to a predetermined temperature and time interval to reduce or eliminate foodborne pathogens present in the food products.

In one aspect, a specially made heating assembly designed for reducing foodborne pathogens in bagged food products is provided. The assembly comprises a treatment chamber, multiple high temperature natural gas fired furnaces, multiple ductworks, a cooling system that allows air to be controlled and supplied into the treatment chamber, multiple temperature sensor probes, a digital control system, and a computer program that monitors the furnace and the product tempering process in each probe. Dry bags containing food products are placed on a specially designed racking system inside the treatment chamber. The specially designed racking system allows multiple dry bags to be stacked in a manner that enables the entirety of each bag to be rapidly and uniformly heated, thus resulting in thorough heat absorption by the products. In particular, the racking system has multiple levels that suspend the bags such that air circulates on top, bottom, and sides of each bag.

The treatment chamber may comprise a self-contained unit connected to a building, wherein the floor, walls, and ceiling of the unit are insulated by a high heat resistant material encapsulated in a stainless steel liner. Each gas fired furnace comprises a heat transfer chamber, a high speed blower unit, and a chimney exhaust flume. Each gas fired furnace is further connected to a ductwork. Each ductwork comprises a system of multiple intake and exhaust ducts that are also insulated by the high heat resistant material and connected to multiple evenly placed vents along lower, middle, and upper wall sections of the treatment chamber.

The gas fired furnaces capture air with the high speed blower units, presses the air to the heat transfer chambers to heat up the captured air, pushes the heated air through the intake ducts and discharges the heated air to the treatment chamber through the intake vents, circulates inside the treatment chamber across the bagged food products, exits out of the exhaust vents and through the exhaust ducts, and returns to the gas fired furnaces. The circulation of hot air enclosed within the ductworks along the walls of the treatment chamber provides a closed air heat system in which the bagged products are never directly in contact with the furnace heat source.

Multiple temperature sensor probes, or thermocouples, are placed in the gas fired furnaces, various zones of the treatment chamber and the dry bags containing food products. The temperature sensor probes are integrated with a sophisticated, computerized data monitoring and recording system that simultaneously monitors and records the temperatures inside the treatment chamber, the gas fired furnaces, and the dry bags to allow a controlled environment and treatment process. For example, when a pre-programmed treatment process has reached a certain predetermined temperature level and remained at that temperature level for a period of time, the system is programmed to notify and shutdown the heating process to prevent condensation and moisture build up from forming inside the bags, and consequently, negatively affecting the food products.

In another aspect, a method of reducing foodborne pathogens in bagged food products using heat treatment is provided. The method comprises providing an insulated heat treatment chamber, placing the bagged food products in the insulated treatment chamber, supplying heat to the insulated treatment chamber using multiple natural gas fired furnaces, circulating heat through the insulated treatment chamber using multiple ductworks, and monitoring temperatures in the insulated treatment chamber, the multiple natural gas fired furnaces, and the bagged food products simultaneously.

The step of providing an insulated heat treatment chamber comprises providing a self-contained unit connected to a building, wherein the floor, walls, and ceiling of the unit are insulated by high heat resistant material encapsulated in a stainless steel liner.

The step of placing the bagged food products in an insulated treatment chamber comprises providing a racking system with multiple levels that suspends the bagged food products on the racking system such that air circulates on top, bottom, and sides of each bag.

The step of supplying heat to the insulated treatment chamber using multiple natural gas fired furnaces comprises capturing air with high speed blower units in the furnaces, pressing the air through heat transfer chambers in the furnaces to heat up the captured air, and discharging the heated air into the treatment chamber.

The step of circulating heat through the insulated treatment chamber using multiple ductworks comprises connecting multiple insulated intake ducts and exhaust ducts to multiple intake vents and exhaust vents evenly along lower, middle, and upper wall sections of the insulated treatment chamber, discharging the heated air from the furnaces into the treatment chamber, pushing the heated air through the suspended bagged food products on the racking system and out of the exhaust vents and exhaust ducts back to the furnaces.

The step of monitoring temperatures in the insulated treatment chamber, the multiple natural gas fired furnaces, and the bagged food products simultaneously further comprises providing multiple temperature sensor probes in the treatment chamber, the gas fired furnaces, and the bagged food product and providing a computer program to monitor the temperature of each temperature sensor probe.

In yet another aspect, a method of assembling a heat treatment assembly for reducing foodborne pathogens in bagged food products using heat treatment is provided. The method comprises configuring an insulated heat treatment chamber, assembling multiple ductworks to the heat treatment chamber, providing a heat source that supplies heat into the heat treatment chamber and uniformly circulates the heat around the bagged food products, installing multiple temperature probes to monitor the temperature of the heat treatment chamber and the bagged food products, communicating the multiple temperature probes to a computer program to ensure completion of the treatment, and constructing a racking system that allows multiple bagged food products to uniformly absorb heat.

The step of configuring an insulated heat treatment chamber comprises constructing an elongated chamber wherein the chamber's walls, floor and ceiling are insulated with high temperature heat resistant insulation material encased in stainless steel liner, and wherein one side wall comprises multiple intake vents configured to receive insulated intake ducts and a corresponding opposite side wall comprises multiple exhaust vents configured to receive insulated exhaust ducts.

The step of assembling multiple ductworks to the heat treatment chamber comprises installing multiple intake ducts on the exterior of one side wall of the heat treatment chamber and multiple exhaust ducts on the exterior of the opposite side wall of the heat treatment chamber.

The step of providing a heat source that supplies heat into the heat treatment chamber and uniformly circulates the heat around the bagged food products comprises connecting multiple natural gas fired furnaces to the multiple ductworks, wherein the furnaces capture the air, heat the air inside a fire box of each furnace, and push the heated air using a blower fan installed within each furnace through the multiple ductworks, around the bagged food products inside the chamber, and back to the furnaces.

The step of installing multiple temperature probes to monitor the temperature of the heat treatment chamber and the bagged food products further comprises placing a plurality of chamber thermocouple sensors on the interior of the side wall and placing a plurality of food product thermocouple sensors in even spacing along the interior of both side walls, wherein the food product thermocouple sensors further penetrate the bags containing the food products.

The step of communicating the multiple temperature probes to a computer program to ensure completion of the treatment further comprises interactively interfacing the chamber thermocouple sensors and the food product thermocouple sensors to a thermocouple control panel, a main electrical control panel, and a computer program to allow exchange of data and information in real time regarding temperatures of the furnaces, the treatment chamber, the bagged food products, gas pressure and process timing.

The step of constructing a racking system that allows multiple bagged food products to uniformly absorb heat further comprises connecting four upper horizontal beams and four lower horizontal beams to four elongated vertical beams that are longer in length than the horizontal beams at their respective ends so as to form an upright rectangular cuboid, placing a plurality of wire shelves along the vertical beams, and configuring four wheels on the bottom corners of the racking assembly.

### BRIEF DESCRIPTION OF THE DRAWINGS

FIG. 1 is a perspective north side view of a preferred embodiment of a heating assembly for reducing foodborne pathogens in bagged food products.

FIG. 2 is a perspective south side view of the preferred embodiment of the heating assembly.

FIG. 3 is an exterior side view of the north side of the preferred embodiment of the heating assembly.

FIG. 4 is an exterior side view of the south side of the preferred embodiment of the heating assembly.

FIG. 5 is a perspective close up view of a portion of the north side of the preferred embodiment of the heating assembly.

FIG. 6 is a perspective close up view of a portion of the south side of the preferred embodiment of the heating assembly.

FIG. 7 is a perspective close up view of a preferred embodiment of an immersion tube burner assembly.

FIG. 8 is a perspective close up view of a second preferred embodiment of an immersion tube burner assembly.

FIG. 9 is a perspective view of a preferred embodiment of an air collector assembly.

FIG. 10 is an inside view of a preferred embodiment of a treatment chamber.

FIG. 11 is a perspective, close up view of a louvered vent and a damper fan assembly.

FIG. 12 is a side view of the damper fan assembly.

FIG. 13 is a panned out side view of the damper fan assembly attached to the treatment chamber as enclosed within a housing.

FIG. 14 is a cross sectional top view of the treatment chamber.

FIG. 15 is a view of a preferred embodiment of a racking system for placing bagged food products inside the treatment chamber.

FIG. 16 is a perspective view of a preferred embodiment of a housing of the heating assembly.

FIG. 17 is a back view of an entrance of the treatment chamber from inside a building.

FIG. 18 is a close up view of a preferred embodiment of a main electrical control panel of the heating assembly.

FIG. 19 is a cross sectional top view of the preferred embodiment of the heating assembly containing the bagged food products.

FIG. 20 is a cross sectional front view of the preferred embodiment of the heating assembly containing the bagged food products.

FIG. 21 is a diagram of a preferred method of reducing foodborne pathogens in bagged food products using heat treatment.

FIG. 22 is a diagram of a preferred method of assembling a heat treatment assembly for reducing foodborne pathogens in bagged food products using heat treatment.

### DETAILED DESCRIPTION OF THE PREFERRED EMBODIMENTS

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

Throughout the specification, positional and directional terms below refer to the following:
“North” or “North Wall” shall refer to the side of a heating assembly in which intake vents are located.
“South” or “South Wall” shall refer to the side of a heating assembly in which exhaust vents are located.

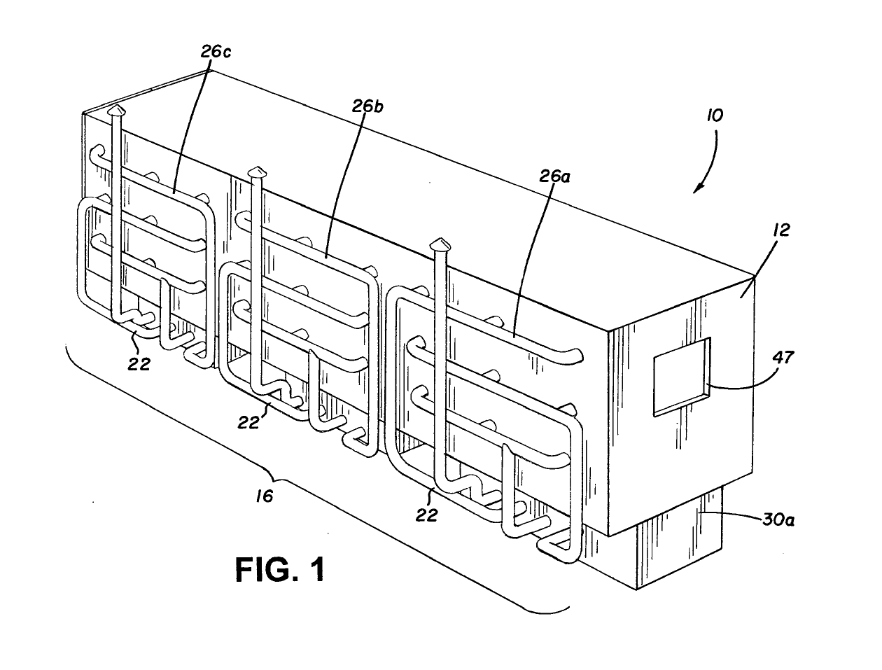

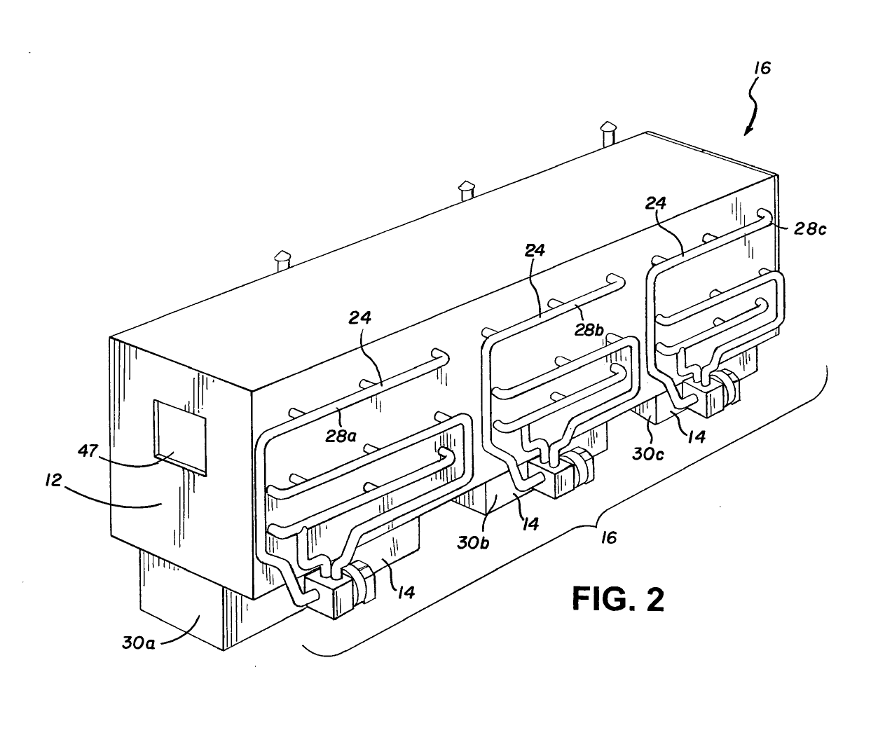

One aspect of the invention provides for a specially made heating assembly designed for reducing foodborne pathogens in bagged food products. In FIG. 1, a preferred embodiment of a heating assembly for reducing foodborne pathogens in bagged food products, or simply heating assembly, is designated generally by the reference numeral 10. Here, an exterior perspective view of the north side of the heating assembly 10 is shown. An exterior perspective view of the south side of the heating assembly 10 is best illustrated in FIG. 2.

As shown in FIGS. 1 and 2, the heating assembly 10 comprises a treatment chamber 12, multiple high temperature natural gas fired furnaces 14, multiple insulated ductworks 16, and multiple temperature sensor probes 18 (not shown in FIG. 1). Preferably, the treatment chamber 12 has the dimension of 53 feet in length, 9 feet in height and 8 feet in width, and the multiple gas fired furnaces 14 comprise three identical furnaces wired in series—a first furnace assembly 30a, a second furnace assembly 30b, and a third furnace assembly 30c—installed on the underside of the treatment chamber 12. Further, each of the furnaces 14 preferably provides 500,000 BTUs to the treatment chamber 12. The multiple insulated ductworks 16 comprise multiple intake ducts 22 and multiple exhaust ducts 24 wrapped in condensed high temperature insulating material that assists in retaining heat inside of the ductworks. In the preferred embodiment, the multiple intake ducts 22 further comprise three identical sets of intake ducts—a first set of intake ducts 26a, a second set of intake ducts 26b, and a third set of intake ducts 26c. The multiple intake ducts 22 are installed on the exterior of the north side of treatment chamber 12. Similarly, the multiple exhaust ducts 24 preferably further comprise three identical sets of exhaust ducts—a first set of exhaust ducts 28a, a second set of exhaust ducts 28b, and a third set of exhaust ducts 28c. The multiple exhaust ducts 24 are installed on the exterior of the south side of the treatment chamber 12. A damper door opening 47 that can be opened to release hot air out of the treatment chamber 12 is located on the west side of the treatment chamber 12.

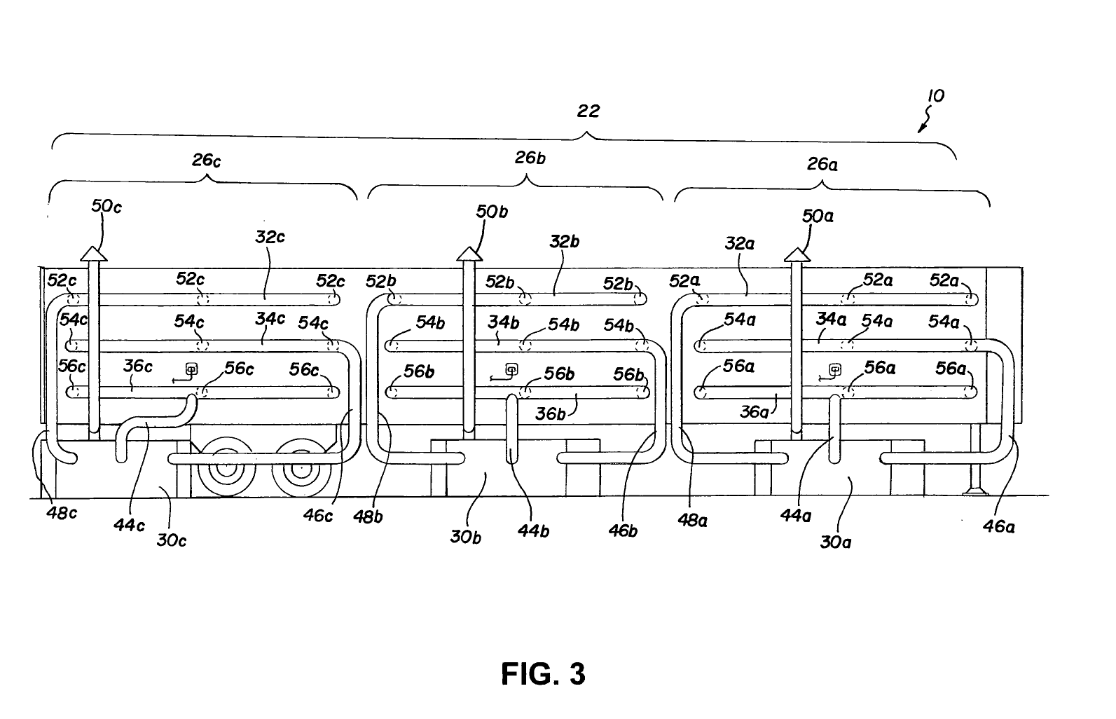

FIG. 3 illustrates an exterior side view of the north side of the heating assembly 10. As seen here, the first set of intake ducts 26a is connected to the first furnace assembly 30a, the second set of intake ducts 26b is connected to the second furnace assembly 30b, and the third set of intake ducts 26c is connected to the third furnace assembly 30c. The first set of intake ducts 26a further comprises an upper intake duct 32a, a middle intake duct 34a, a lower intake duct 36a, and an exhaust chimney 50a. An upper intake connector duct 48a connects the first furnace assembly 30a to the upper intake duct 32a. The upper intake duct 32a is connected to the north side of the treatment chamber 12 at three upper intake vents 52a. A middle intake connector duct 46a connects the first furnace assembly 30a to the middle intake duct 34a. The middle intake duct 34a is connected to the north side of the treatment chamber 12 at three middle intake vents 54a. A lower intake connector duct 44a connects the first furnace assembly 30a to the lower intake duct 36a. The lower intake duct 36a is connected to the north side of the treatment chamber 12 at three lower intake vents 56a.

The second set of intake ducts 26b and the third set of intake ducts 26c comprise elements of similar structure to the first set of intake ducts 26a, which are designated by the same reference numerals followed by the lower cases “b” and “c,” respectively.

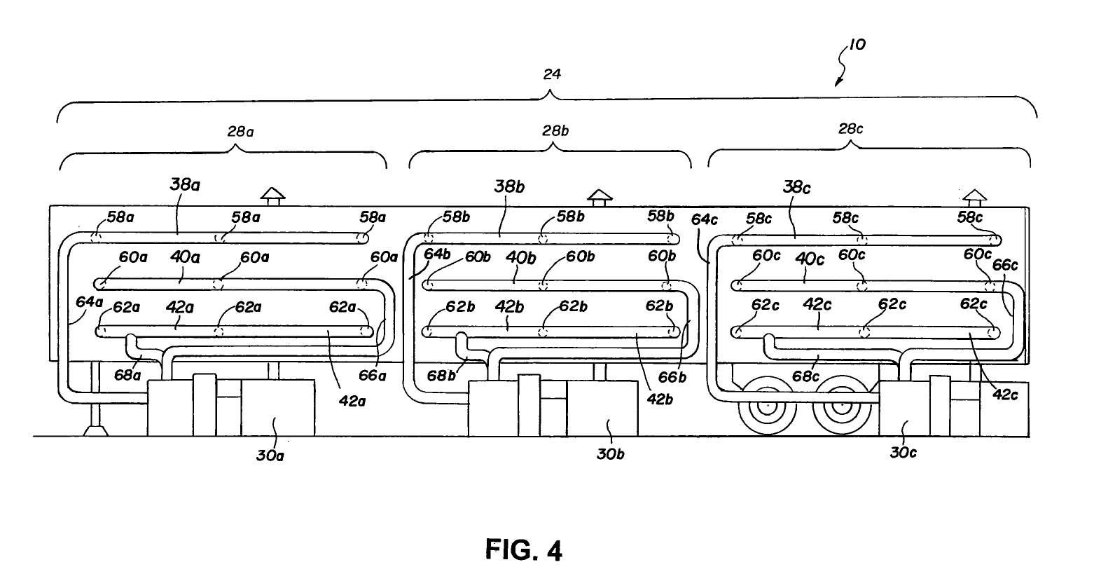

FIG. 4 illustrates an exterior side view of the south side of the heating assembly 10. Here, the first set of exhaust ducts 28a is connected to the first furnace assembly 30a, the second set of exhaust ducts 28b is connected to the second furnace assembly 30b, and the third set of exhaust ducts 28c is connected to the third furnace assembly 30c. The first set of exhaust ducts 28a further comprises an upper exhaust duct 38a, a middle exhaust duct 40a, and a lower exhaust duct 42a. An upper exhaust connector duct 64a connects the first furnace assembly 30a to the upper exhaust duct 38a. The upper exhaust duct 38a is connected to the south side of the treatment chamber 12 at three upper exhaust vents 58a. A middle exhaust connector duct 66a connects the first furnace assembly 30a to the middle exhaust duct 40a. The middle exhaust duct 40a is connected to the south side of the treatment chamber 12 at three middle exhaust vents 60a. A lower connector duct 68a connects the first furnace assembly 30a to the lower exhaust duct 42a. The lower exhaust duct 42a is connected to the south side of the treatment chamber 12 at three lower exhaust vents 62a.

The second set of exhaust ducts 28b and the third set of exhaust ducts 28c comprise elements of similar structure to the first set of exhaust ducts 28a, which are designated by the same reference numerals followed by the lower cases “b” and “c,” respectively.

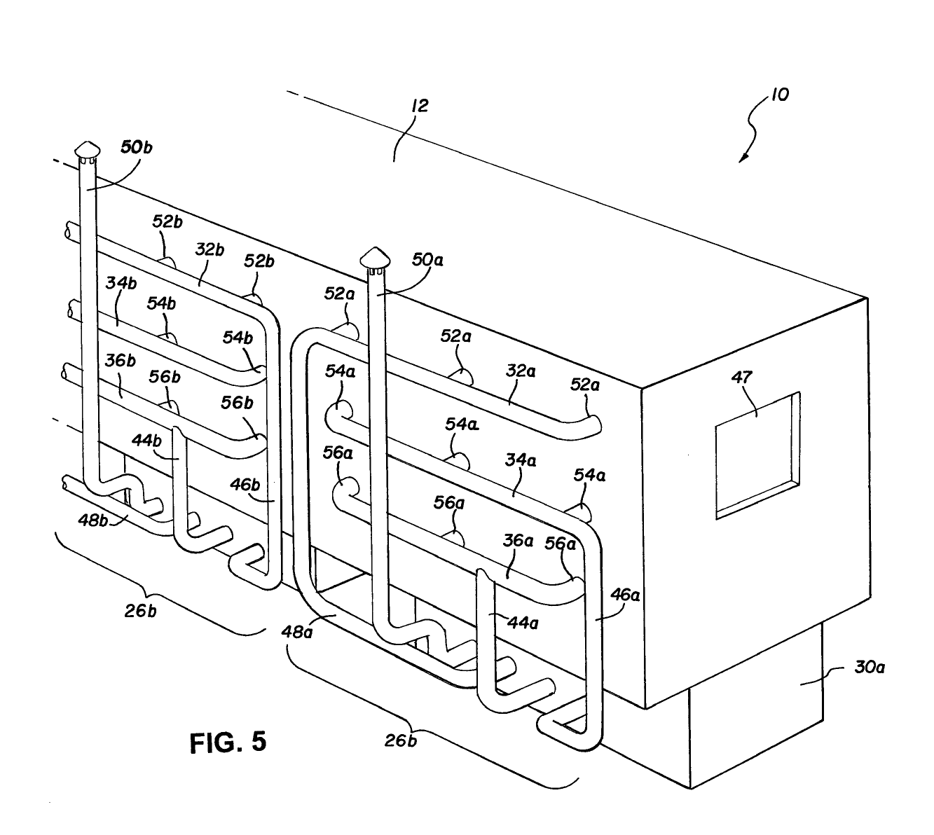

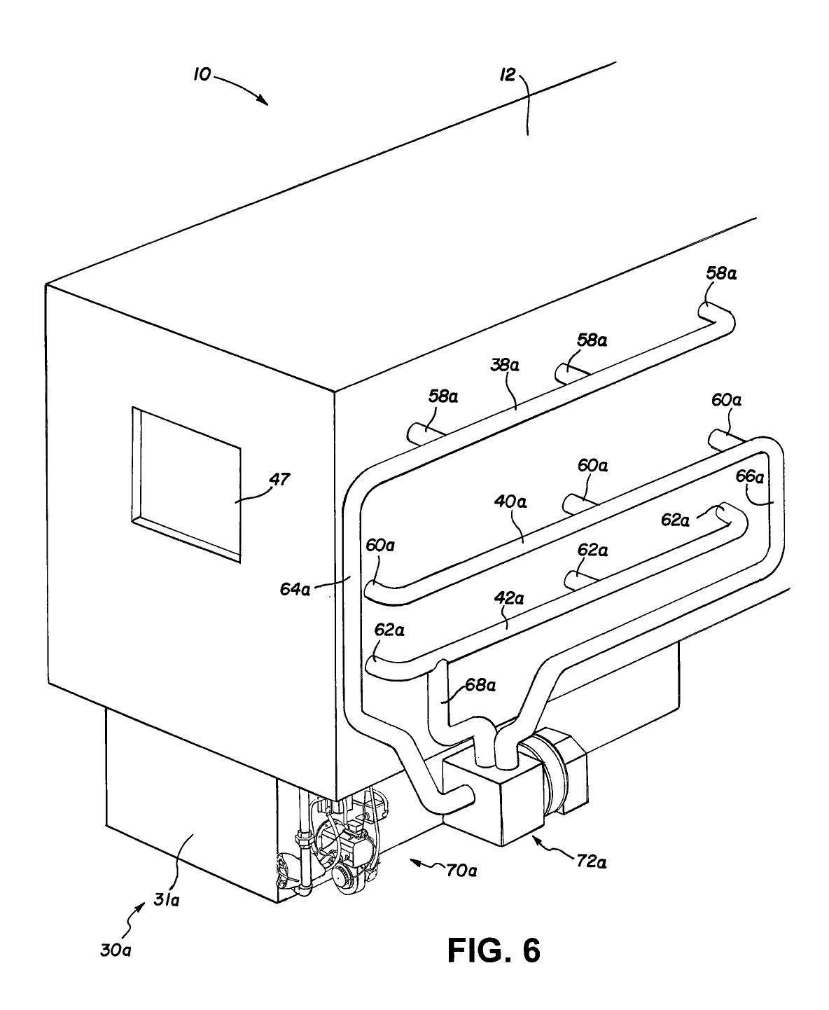

FIG. 5 provides a close up, perspective view of a portion of the north side of the heating assembly 10, showing the first set of intake ducts 26a and the second set of intake ducts 26b and their respective elements described above. FIG. 6 provides a close up, perspective view of a portion of the south side of the heating assembly 10, showing the first set of exhaust ducts 28a. In addition to the elements already described above, FIG. 6 also shows the first furnace assembly 30a comprising a fire box 31a, an immersion tube burner assembly 70a and an air collector assembly 72a. A furnace thermocouple sensor 33a (not shown in FIG. 6) that monitors the temperature of the furnace assembly 30a is placed inside the fire box 31a.

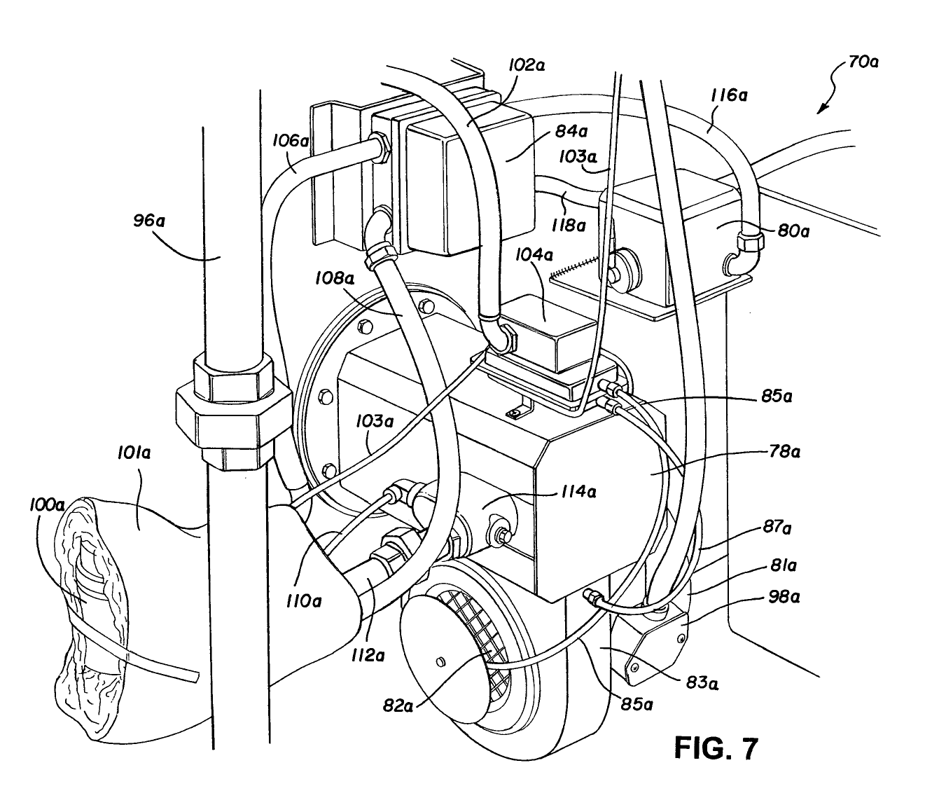

FIG. 7 illustrates a close up, perspective view of the immersion tube burner assembly 70a. The immersion tube burner assembly 70a comprises a gas valve regulator 100a, an immersion tube burner 78a, a pressure switch 104a, an ignition transformer 80a, and a digital immersion tube burner monitoring system control box, or simply a burner control box, 84a. By way of example and not as limitation, commercially available immersion tube burner monitoring systems, such as the Veri-Flame Burner Monitoring System by Eclipse, may be used. The immersion tube burner 78a further comprises a blower fan motor 81a and a blower fan 82a in a blower fan housing 83a. A coupling connector 85a couples the pressure switch 104a to the blower fan 82a, and an air tube 87a connects the pressure switch 104a to the blower fan housing 83a. Preferably, the coupling connector 85a is made of copper and the tube 87a is made of plastic. Further, a first electrical conduit 102a connects the blower fan 82a and the pressure switch 104a. A heating cord 103a connects the pressure switch 104a to the gas valve regulator 100a. The heating cord 103a helps prevent the pressure switch 104a from freezing and sticking in cold weather.

The gas valve regulator 100a is insulated by an insulation sleeve 101a and connected to a main gas line pipe 96a. A second electrical conduit 106a and a third electrical conduit 108a connect the gas valve regulator 100a to the burner control box 84a. A first gas feed 110a and a second gas line feed 112a connect the gas valve regulator 100a to a mount coupler 114a, which in turn couples the first gas feed 110a and the second gas line feed 112a to the immersion tube burner 78a. A fourth electrical conduit 116a and a fifth electrical conduit 118a connect the ignition transformer 80a to the burner control box 84a.

A second immersion tube burner assembly 70b (not shown in FIG. 7) of the second furnace assembly 30b and a third immersion tube burner assembly 70c (not shown in FIG. 7) of the third furnace assembly 30c comprise elements of similar structure to the first immersion tube burner assembly 70a, which are designated by the same reference numerals followed by the lower cases “b” and “c,” respectively.

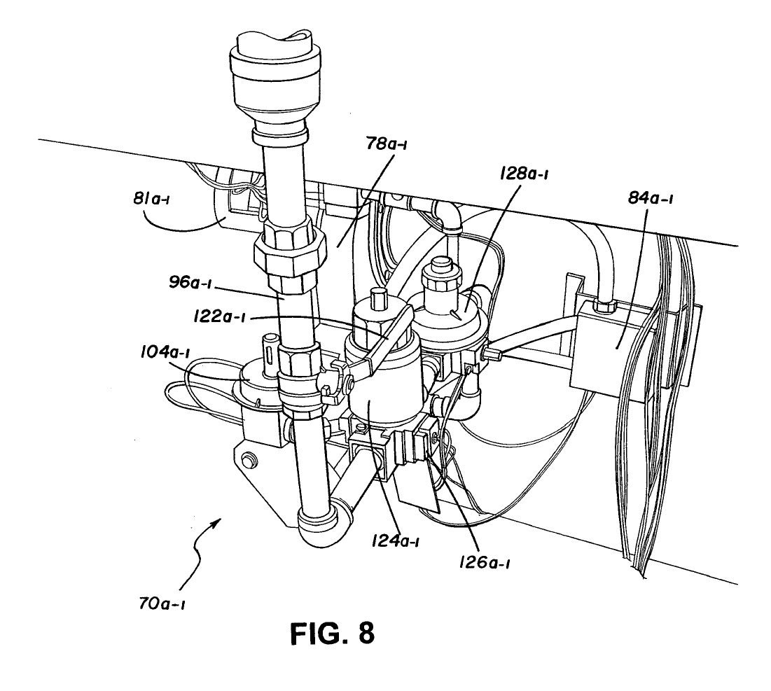

FIG. 8 shows a perspective view of a second preferred embodiment of the immersion tube burner assembly 70a-1, where elements of similar structure are designated by the same reference numerals followed by “-1”. Here, the immersion tube burner 78a-1 includes the immersion tube burner blower fan motor 81a-1, wherein the immersion tube burner 78a-1 is further connected to a pressure switch valve 104a-1. The main gas line pipe 96a-1 further comprises a manual gas/air flow lever 122a-1, which turns on or off the gas supply into the assembly. The main gas line pipe 96a-1 is connected to a solenoid gas valve 124a-1 and a pressure regulator 128a-1, wherein the solenoid gas valve further comprises a safety shut-off valve 126a-1. By way of example and not as limitation, commercially available solenoid gas valves, such as the Dungs valve, may be used. The pressure regulator 128a-1 is further connected to the burner control box 84a-1.

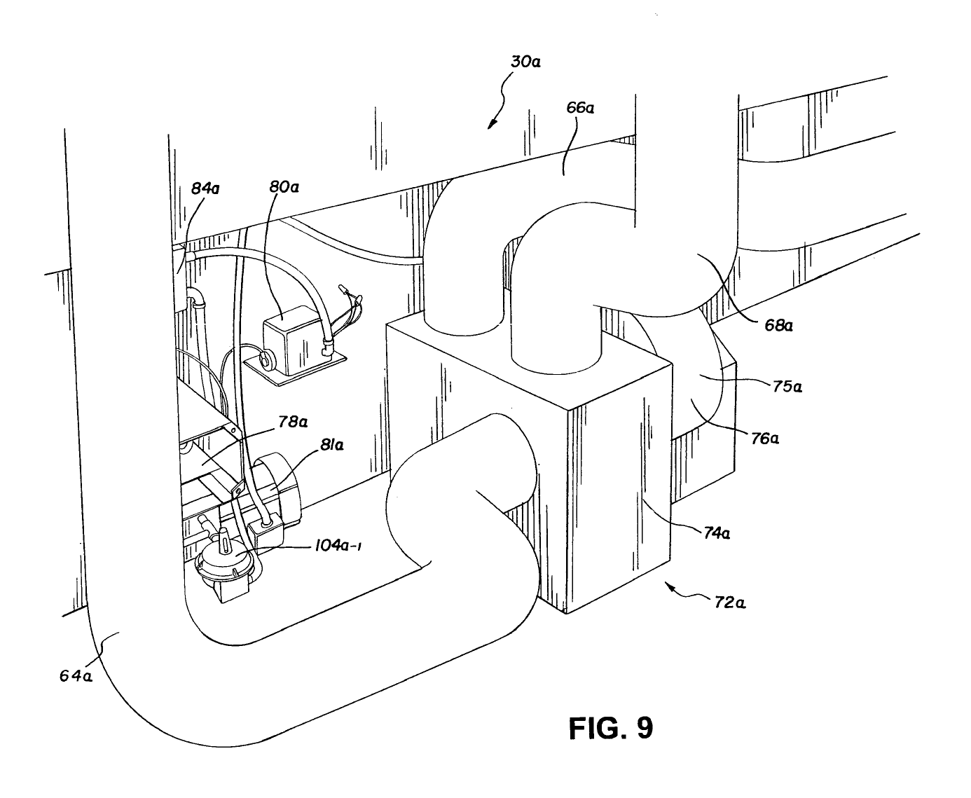

FIG. 9 illustrates a perspective view of the air collector assembly 72a. As shown, the air collector assembly 72a comprises an air collector box 74a and a furnace blower fan 75a (not shown in FIG. 9). The furnace blower fan 75a is housed inside a furnace blower fan housing 76a. The upper exhaust connector duct 64a, the middle exhaust connector duct 66a, and the lower exhaust connector duct 68a are connected to the air collector box 74a, returning hot air from the treatment chamber 12 to the first furnace assembly 30a.

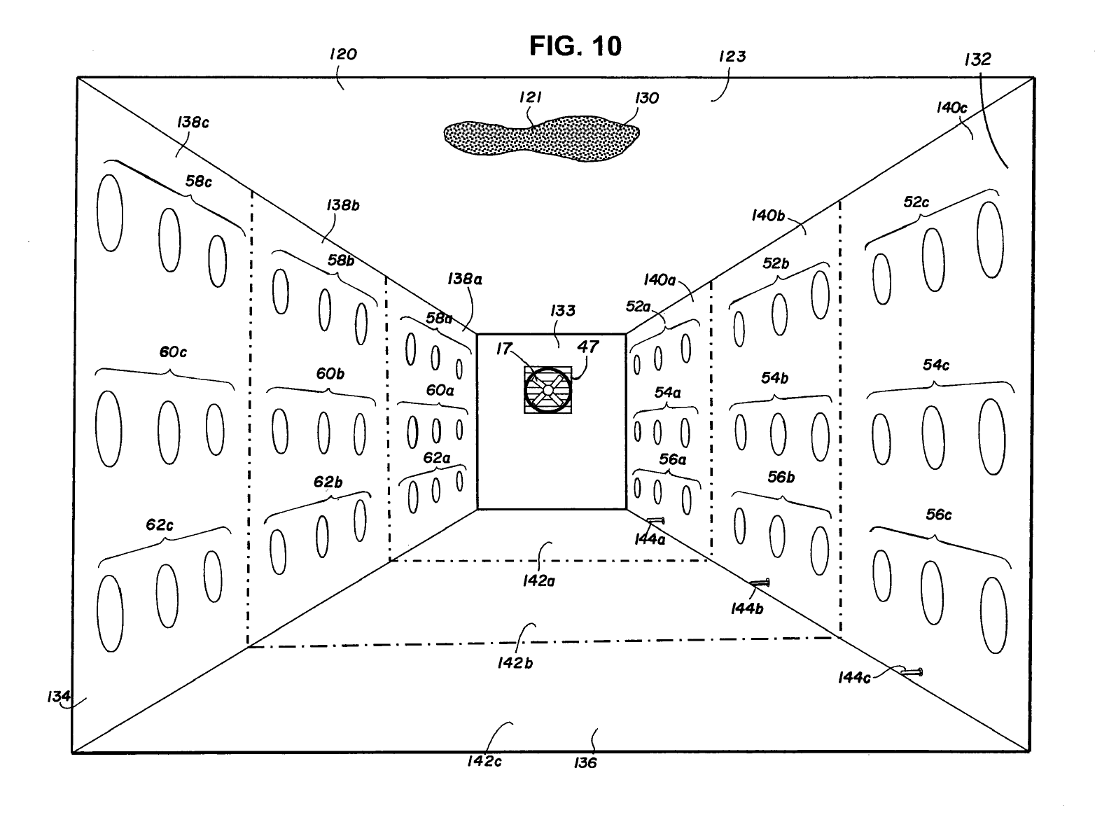

FIG. 10 illustrates an inside view of the treatment chamber 12. The treatment chamber 12 comprises a ceiling 120, an east wall/entrance 131 (not shown in FIG. 10), a north wall 132, a west wall 133, a south wall 134, and a floor 136. The treatment chamber 12 is completely insulated with high temperature heat resistant insulation material 121 encased in stainless steel liner 123, as demonstrated in a cutaway portion 130. In a preferred embodiment, the treatment chamber 12 is divided into multiple sections or zones. In the preferred embodiment, the north wall 132 is further divided into three sections, a first north wall section 140a, a second north wall section 140b, and a third north wall section 140c. Correspondingly, the south wall 134 is divided into three sections, a first south wall section 138a, a second south wall section 138b, and a third south wall section 138c. The first north wall section 140a comprises the upper intake vents 52a, the middle intake vents 54a, and the lower intake vents 56a. The second north wall section 140b and the third north wall section 140c comprise elements of similar structure to the first north wall section 140a, which are designated by the same reference numerals followed by the lower cases “b” and “c,” respectively. The first south wall section 138a comprises the upper exhaust vents 58a, the middle exhaust vents 60a, and the lower exhaust vents 62a. The second south wall section 138b and the third south wall section 138c comprise elements of similar structure to the first south wall section 138a, which are designated by the same reference numerals followed by the lower cases “b” and “c,” respectively. In the preferred embodiment, the three dimensional area enclosed within the imaginary border of the first north wall section 140a and the first south wall section 138a form a first zone 142a; the three dimensional area enclosed within the imaginary border of the second north wall section 140b and the second south wall section 138b form a second zone 142b; and the three dimensional area enclosed within the imaginary border of the third north wall section 140c and the third south wall section 138c form a third zone 142c. Also shown in FIG. 10 are a first chamber thermocouple 144a, a second chamber thermocouple 144b, and a third chamber thermocouple 144c located on the north wall 132, and the damper door opening 47 and a damper fan assembly 17 located on the west wall 133.

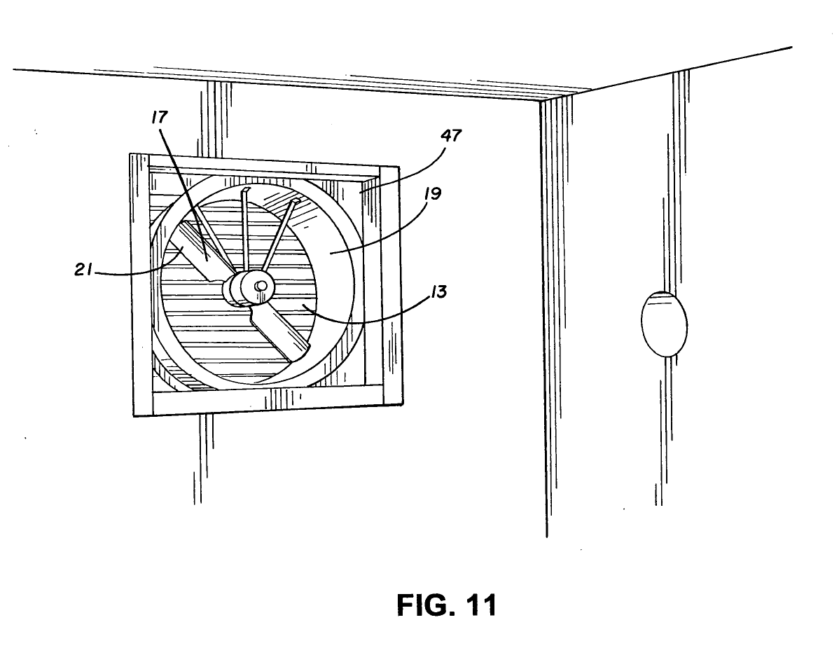

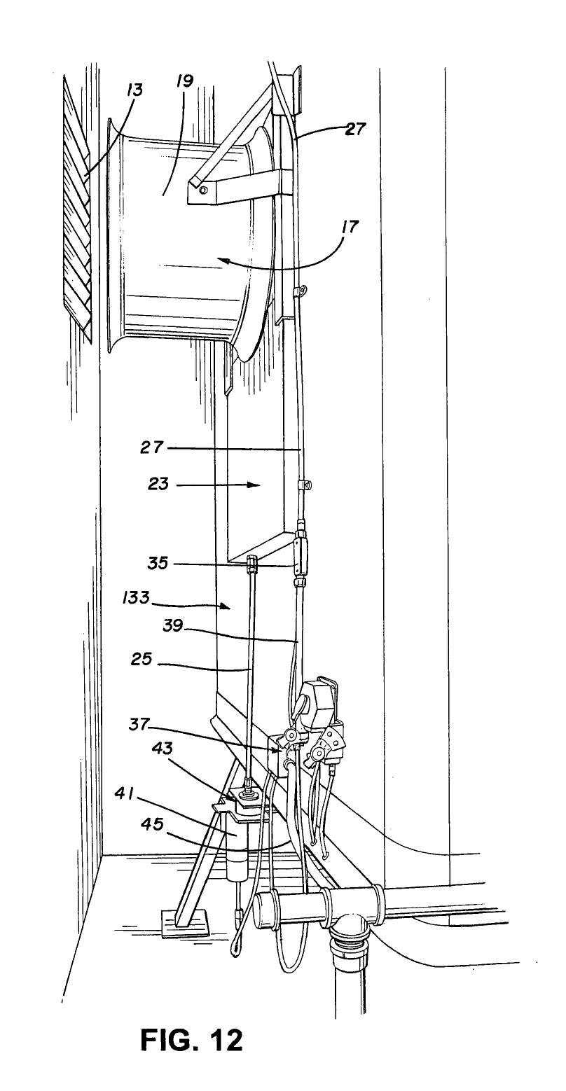

FIG. 11 illustrates a perspective, close up view of a louvered vent 13 and the damper fan assembly 17. As shown, the damper fan assembly 17 comprises damper fan blades 21 housed in a damper fan housing 19. The damper fan assembly 17 is located in front of the louvered vent 13. FIG. 12 provides a side view of the damper fan assembly 17. A damper door 23 is installed on the west wall 133, wherein the damper door 23 is vertically movable upward and downward along a track 25, to allow the damper fan assembly 17 to be opened or closed to the treatment chamber 12. According to one embodiment, the damper fan housing 19 is tubular in shape, preferably having a length of 23 inches and a thickness of 3/16 of an inch, and placed approximately 3 inches from the louvered vent 13. An upper switch conduit 27 is connected to an upper limit switch 29 (not shown in FIG. 12) that shuts off the damper door 23 when the damper door 23 is closed to the treatment chamber 12 and a lower limit switch 35 that communicates with a damper door motor 41 to open or close the damper door 23 depending on the position of the damper door 23 along the track 25.

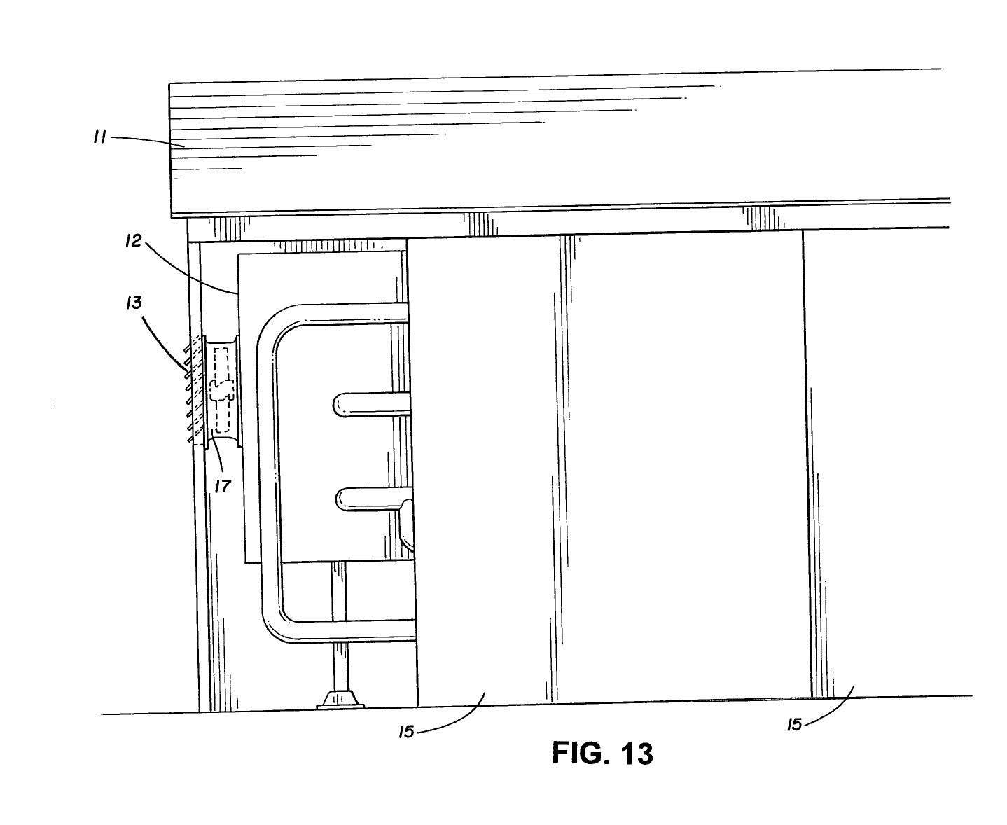

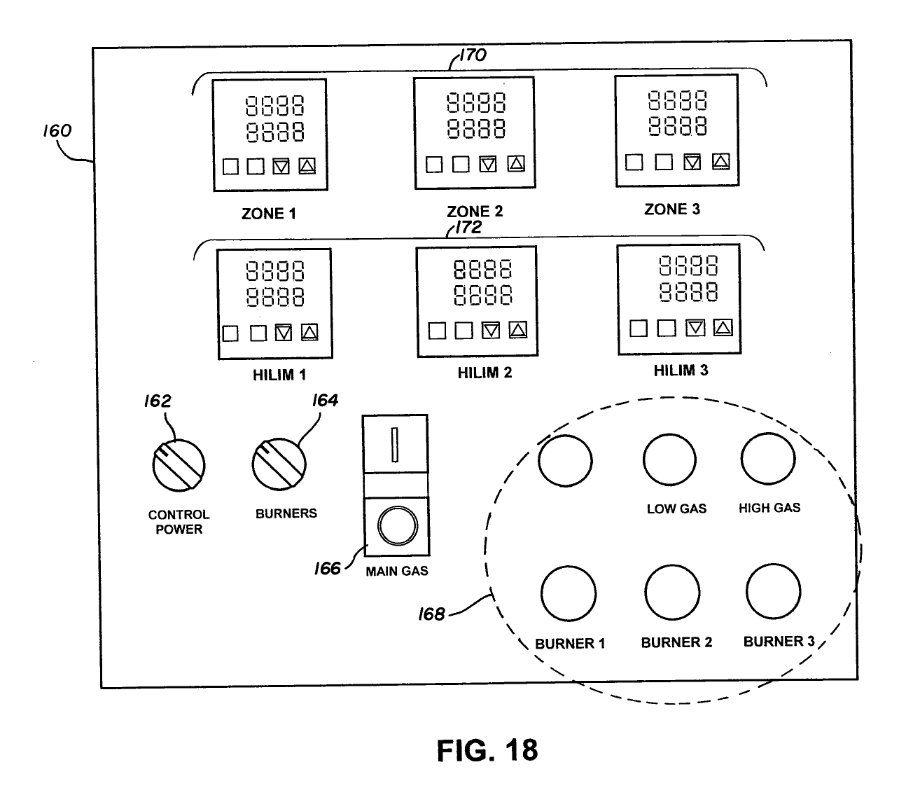

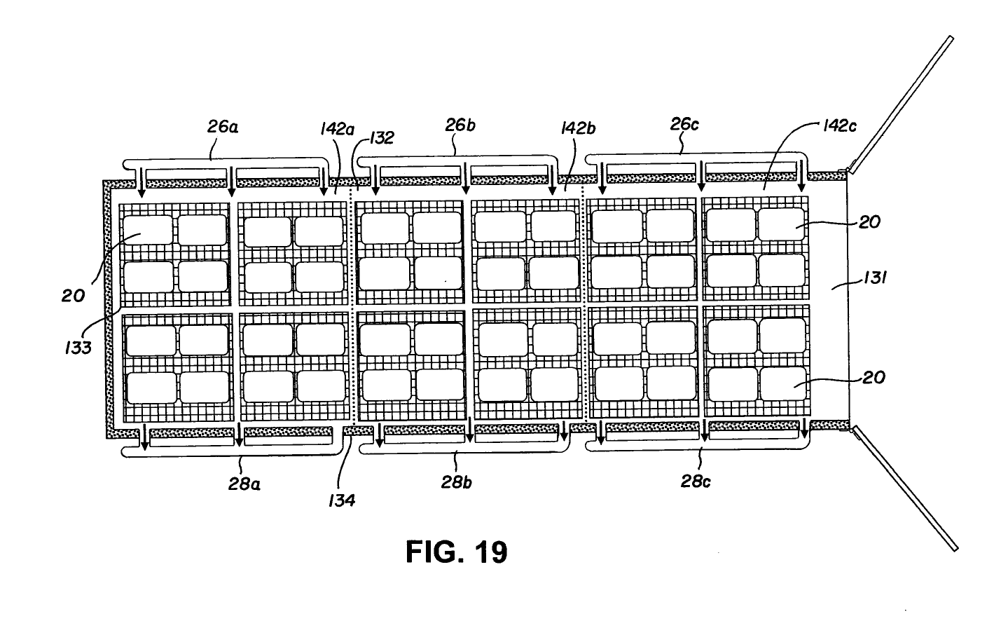

The lower switch 35 is further connected to a junction box 37 by a lower switch conduit 39, wherein the junction box 37 communicates with the damper door motor 41 to engage damper door gears 43 to raise (close) and lower (open) the damper door 23. Additionally, an electrical line 45 connects the junction box 37 to a main electrical panel 160 (shown in FIGS. 18 and 19) that controls the operation of the multiple furnaces 14 and temperature monitoring of the treatment chamber 12. FIG. 13 shows a panned out side view of the damper fan assembly 17 attached to the treatment chamber 12 as enclosed within a housing 11, which will be described in further details below.

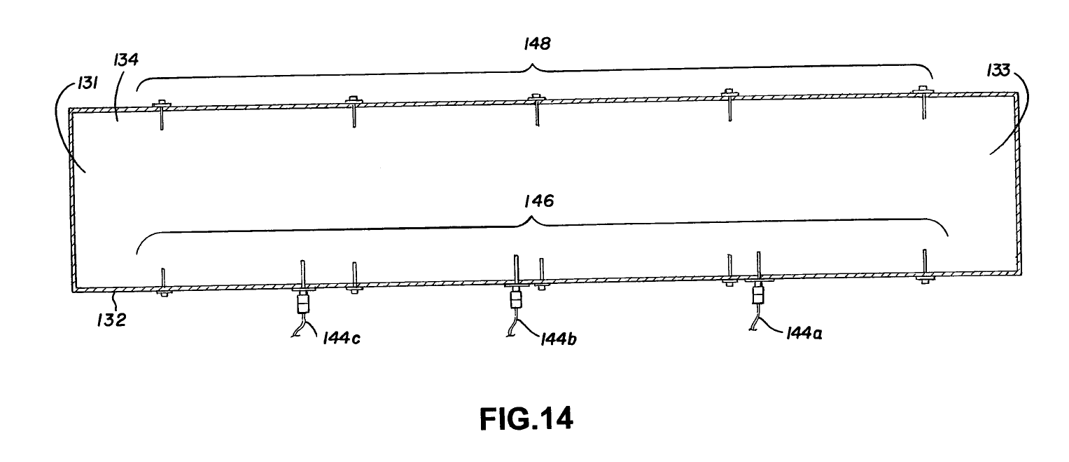

FIG. 14 illustrates a cross sectional top view of the treatment chamber 12. As shown in FIGS. 10 and 14, multiple thermocouple sensors are evenly placed inside the treatment chamber 12 to monitor the temperature of the treatment chamber 12 and bagged food products 20 (not shown in FIGS. 10 and 14). According to one embodiment, the first chamber thermocouple 144a is placed at the bottom of the first north wall section 140a, the second chamber thermocouple 144b is placed at the bottom of the second north wall section 140b, and the third chamber thermocouple 144c is placed at the bottom of the third north wall section 140c. Suitable thermocouples for the chamber thermocouples 144a, 144b, and 144c may comprise “K” thermocouples. Preferably, the “K” thermocouples are at least 8 inches in length. Additionally, a first plurality of food product thermocouples 146 is evenly placed along the north wall 132 and a second plurality of food product thermocouples 148 is evenly placed along the south wall 134. In one embodiment, the first plurality of food product thermocouples 146 comprises five thermocouples and the second plurality of food product thermocouples 148 comprises five thermocouples. Suitable thermocouples for the food product thermocouples 146 and 148 may comprise “T” thermocouples, each having an extension cord at sufficient length that allows insertion at various heights and locations on a racking system described below, where the bagged food products 20 are placed. Preferably, each of the food product thermocouples 146 and 148 is at least 12 inches in length with an extension cord of at least 8 feet in length, and comprises a metal rod with a brass wire on one side and an aluminum wire on the other side inside the rod.

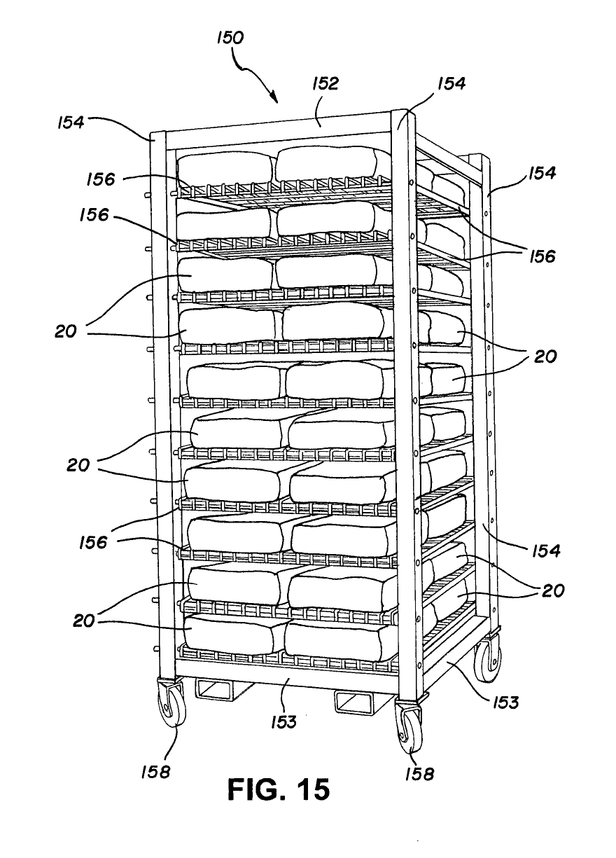

FIG. 15 illustrates a racking system comprising a wire rack 150 used to place the bagged food products 20 inside the treatment chamber 12. As shown in FIG. 15, the wire rack 150 further comprises four horizontal beams 152 on the top, four horizontal beams 153 on the bottom, and four elongated vertical beams 154 that are longer in length than the horizontal beams 152 and 153. The top horizontal beams 152 and the vertical beams 154, as well as the bottom horizontal beams 153 and the vertical beams 154, are connected at their respective ends so as to form an upright rectangular cuboid. A plurality of wire shelves 156 is evenly placed along the vertical beams 154, such that the bagged food products 20 are evenly stacked and the heated air completely flows around each bag for more uniform heating. Preferably, the wire rack 150 comprises ten wire shelves 156 and four wheels 158 on the bottom corners to allow easy movement of the bagged food products 20 in and out of the treatment chamber 12. When the bagged food products 20 are placed in the wire racks 150, the wire racks 150 are configured to provide multiple levels that suspend the bagged food products 20 such that the heated air circulates on top, bottom, and sides of each bagged food product 20.

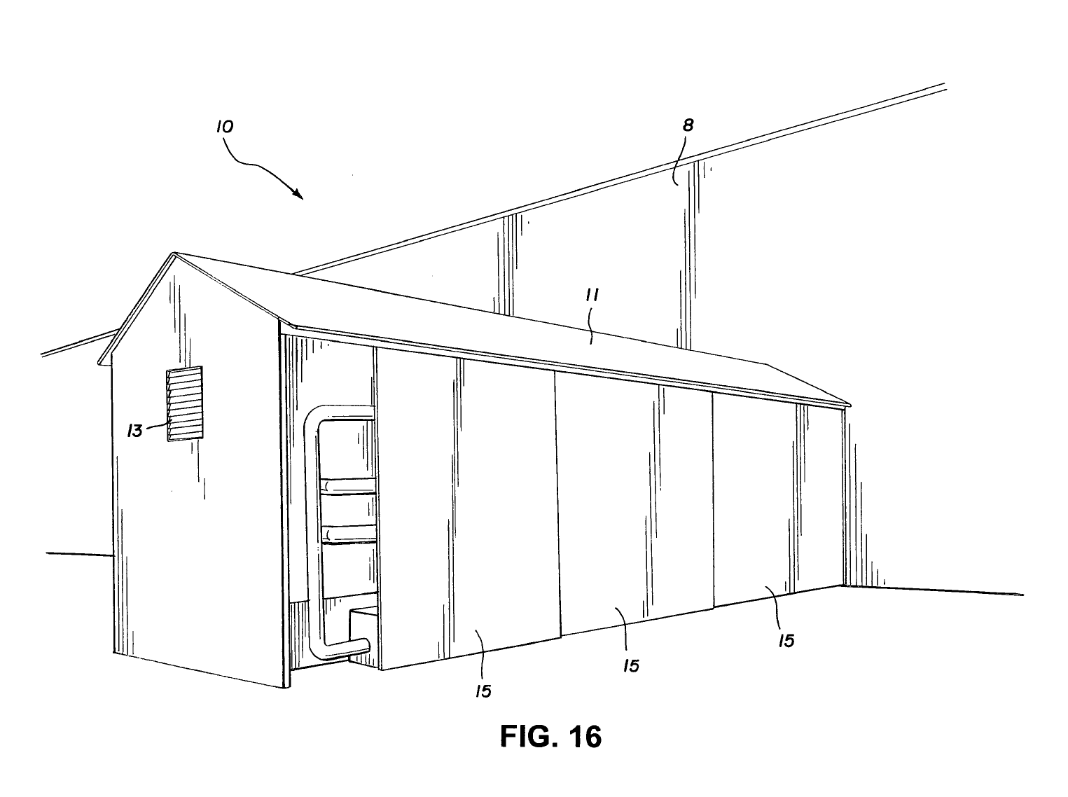

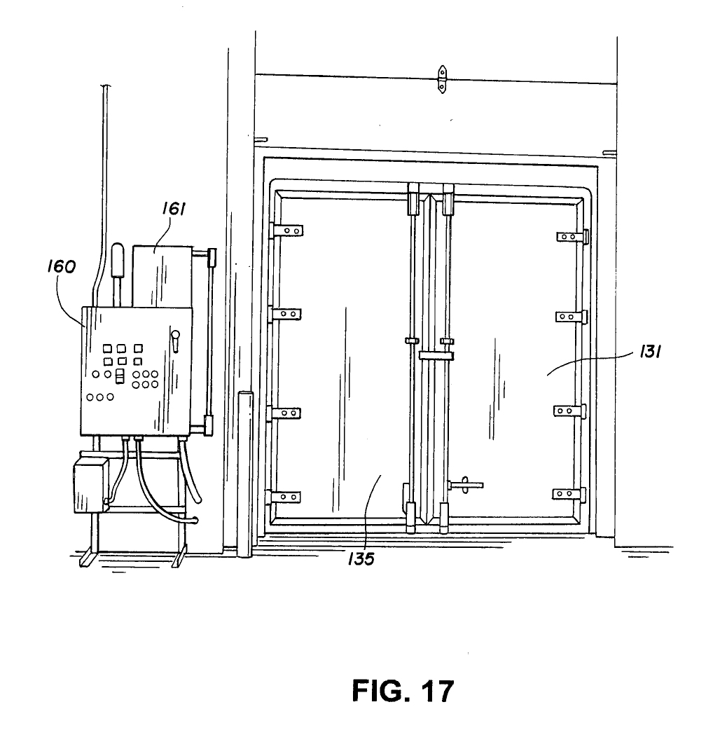

Generally, the heating assembly 10 is designed to be a self-contained unit that is attached to a building. FIG. 16 illustrates the heating assembly 10 being housed in the housing 11, wherein the heating assembly 10 and the housing 11 are attached to a building 8. As shown in FIGS. 13 and 16, the housing 11 further comprises sliding doors 15 to allow easy access to the heating assembly 10. FIG. 17 shows a back view of the east side/entrance 131 of the treatment chamber 12 from inside the building 8. Here, the entrance 131 of the treatment chamber 12 further comprises double doors 135. A thermocouple control panel 161 and the main electrical control panel 160 that controls the operation of the multiple furnaces 14 and temperature monitoring are shown to the left of the double doors 135. In FIG. 18, a close up view of the main electrical control panel is shown. As illustrated, the main electrical control panel 160 comprises a power supply control (on and off) 162, a furnace firing mechanism control 164, a main gas supply control 166, gas flow controls (low and high) 168 of the three furnace assemblies 30a, 30b and 30c, temperature monitoring controls 170 of the three zones 142a, 142b and 142c, and temperature monitoring controls 172 of the three fire boxes 31a, 31b and 31c in the furnaces.

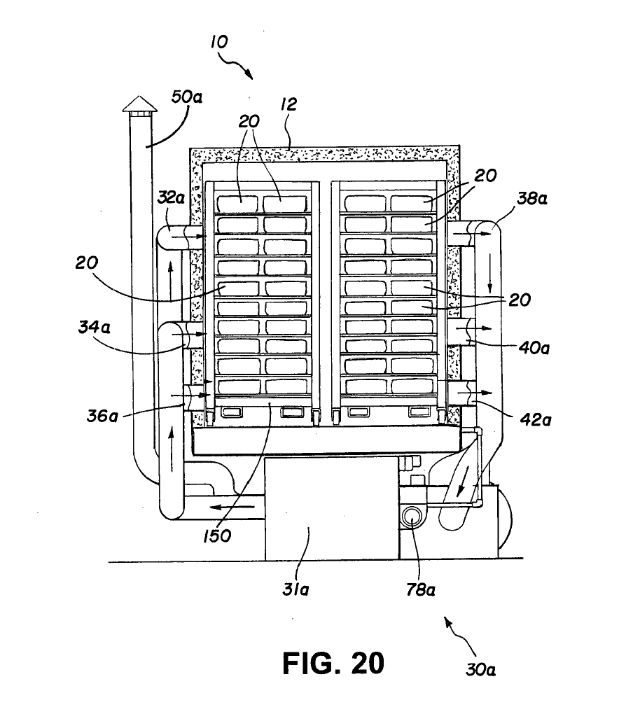

The preferred principle of operation of the heating assembly 10 can be further understood by referring to FIGS. 15-20 and the following description. As seen in FIGS. 15-20, the bagged food products 20 to be treated are placed on the wire racks 150, wherein each wire rack 150 preferably contains ten wire shelves 156, and each wire shelf 156 preferably contains four bagged products 20. The wire racks 150 containing the bagged food products 20 are then placed inside the treatment chamber 12. According to one embodiment, the treatment chamber 12 may contain twenty wire racks 150, or a total of 800 bagged food products 20. After the bagged food products 20 are placed inside the treatment chamber 12, the treatment chamber entrance doors 135 are then closed and locked.

The power supply control 162 and the furnace firing mechanism 164 are turned on, and the multiple gas fired furnaces 14 comprising the furnace assemblies 30a, 30b, and 30c are engaged in step-by-step succession. The first furnace assembly 30a is first ignited and allowed to run, followed by the second furnace assembly 30b and the third furnace assembly 30c. According to one embodiment, the temperature of the furnace assemblies 30a, 30b, and 30c is set to 295° F., while the temperature inside the zones 142a, 142b, and 142c inside the treatment chamber 12 is set to 240° F.

The gas furnaces 14 begin to capture air with the air collector assemblies 72a, 72b and 72c at high speed and press the captured air through the fireboxes 31a, 31b and 31c. The immersion tube burners 78a, 78b and 78c then heat up the air inside the fire boxes 31a, 31b and 31c. The furnace blower fans 75a, 75b and 75c then circulate the air by pushing the heated air inside the fire boxes 31a, 31b and 31c through the multiple intake ducts 22 and the multiple intake vents 52, 54 and 56 on the north side of the treatment chamber 12 into the treatment chamber 12, across the bagged food products 20 placed on the wire racks 150 inside the treatment chamber 12, out of the treatment chamber 12 through the multiple exhaust ducts 24 and the multiple exhaust vents 58, 60 and 62 on the south side of the treatment chamber 12, into the air collector boxes 74a, 74b and 74c, and back into the fire boxes 31a, 31b and 31c to be reheated and recirculated. This cycle continues until the treatment process is complete, which is reached when the thermocouples 146 and 148 start reporting the temperature of the bagged food products have reached a desired level of temperature for a period of time. According to one embodiment, the preferred level of temperature is 170° F. for one hour.

As described above, the treatment chamber is divided into three zones 142a, 142b and 142c. Combined with the wire racks 150 which allow the heated air to completely flow around each bag, the three zones 142a, 142b and 142c provide for a uniform distribution of heat across the bagged food products 20. During the continuous heat treatment, the high temperature slowly penetrates the food products inside the bags. Any heated air not utilized by the heating assembly 10 during the process is released out of the treatment chamber through the exhaust chimneys 50a, 50b and 50c.

The burner control boxes 84a, 84b and 84c provide the safety feature such that if one furnace assembly shuts down for any reason, or if the gas flow changes up or down, a failure process will be initiated to automatically shut down the rest of the heating assembly 10. In particular, the burner control boxes 84a, 84b and 84c provide digital information such as system error, low fire, high fire, flame failure, or air failure. When a failure is detected, the control boxes 84a, 84b and 84c will light up a failure code to indicate the reason for failure. Further, the burner control boxes 84a, 84b and 84c are wired in series and control the furnace ignition processes by having various pressure and temperature switches that activate and stop the furnace assemblies 30a, 30b and 30c. Combined with the pressure regulator 128a-1 and the safety shut-off valve 126a-1 of the solenoid gas valve 124a-1, a break in this circuit will shut down the heating assembly 10. Further, the burner control boxes 84a, 84b and 84c units check the air flow switch input to make sure it is open before start-up, closed during operation, and open again at burner shutdown, thus preventing operation with an air switch that is defective, maladjusted or jumped.

The thermocouple control panel 161 and the main electrical control panel 160 are interactively interfaced with a computer program 174, and exchange data and information in real time regarding temperatures of the furnace assemblies 30a, 30b and 30c, the treatment chamber 12, and the bagged food products 20, as well as gas pressure and process timing. The computer program 174 prints out graphs and charts of said data and information. When the heating assembly 10 is turned on, the various thermocouples and switches start recording the changes that are occurring during the treatment process, including the temperatures in the zones 142a, 142b and 142c, the fire boxes 31a, 31b and 31c, as well as the temperatures inside the bagged food products 20 using the ten thermocouples 146 and 148. The computer program 174 registers a real time reading on a computer monitor showing a current reading of the temperatures of the treatment chamber 12 and the thermocouples 146 and 148 periodically, which in one embodiment comprises a reading in every 30 seconds. The program 174 is set up to show a graph of the temperature changes in relation to the treatment time and record a data table showing the temperature of the ten thermocouples 146 and 148, the three zones 142a, 142b and 142c, and the three furnace assemblies 30a, 30b and 30c periodically, which in one embodiment comprises once in every 15 minutes. When all ten thermocouples 146 and 148 have reached a certain temperature for a certain period of time, such as a temperature of 170° F. for one hour, the program 174 automatically begins to shut down the heating assembly 10. Once the heating assembly 10 has been shut down, the doors 135 and the damper door 23 are opened, and the damper fan assembly 17 is engaged to assist drawing the heated air out of the treatment chamber 12 and drawing the cooler ambient air in through the wire racks 150, to speed up the cool down process. In particular, the damper fan blades 21 and its damper fan motor are configured such that when the damper fan blades 21 are engaged, they draw the heated air in the treatment chamber 12 out. As this heated air starts moving westward and out of the treatment chamber 12, the damper fan blades 21 also draw the cooler ambient air in the treatment chamber 12 and the adjoining warehouse 8 through the double doors 135 that remain open when the cool down process is initiated. The other side of the damper fan blades 21 and the damper fan housing 19 push open the louvered vent 13 that allows the heated air to escape from the treatment chamber 12 and into the outside open air space. After several hours of cooling down, the wire racks 150 containing the bagged food products 20 are taken out of the treatment chamber 12 for further testing and packaging for shipment.

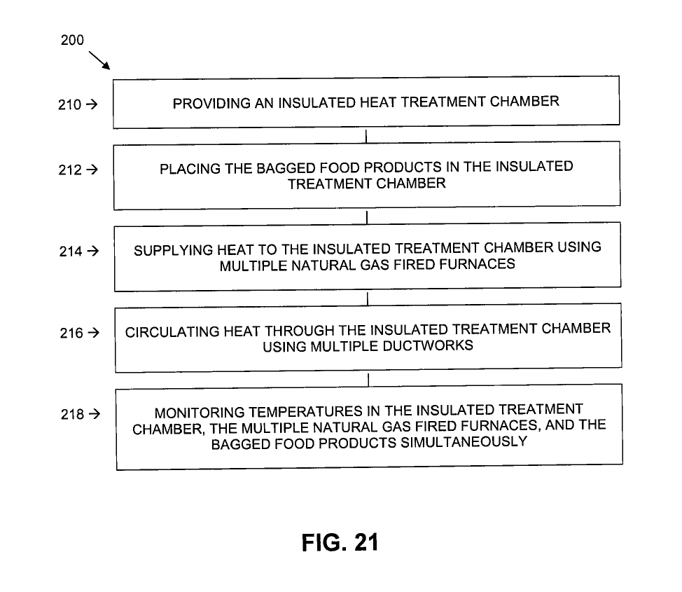

FIG. 21 illustrates a preferred method 200 of reducing foodborne pathogens in bagged food products using heat treatment is provided. The method 200 comprises a step 210 of providing an insulated heat treatment chamber, a step 212 of placing the bagged food products in the insulated treatment chamber, a step 214 of supplying heat to the insulated treatment chamber using multiple natural gas fired furnaces, a step 216 of circulating heat through the insulated treatment chamber using multiple ductworks, and a step 218 of monitoring temperatures in the insulated treatment chamber, the multiple natural gas fired furnaces, and the bagged food products simultaneously.

The step 210 of providing an insulated heat treatment chamber comprises providing a self-contained unit connected to a building, wherein the floor, walls, and ceiling of the unit are insulated by high heat resistant material encapsulated in a stainless steel liner.

The step 212 of placing the bagged food products in an insulated treatment chamber comprises providing a racking system with multiple levels that suspends the bagged food products on the racking system such that air circulates on top, bottom, and sides of each bag. Preferably, prior to placing the bagged food products in the chamber, the temperatures inside randomly selected bags are taken to validate the thermal couple sensors and the temperature inside the bags prior to treatment. All of the bags are also inspected for breach in packaging, and if necessary, some of the bags are glued with masking tape for reinforcement prior to placing them in the treatment chamber. Subsequently, the bags are placed on the racking system. According to a preferred embodiment, the racking system comprises ten shelves with four bags sitting on each shelf.

The step 214 of supplying heat to the insulated treatment chamber using multiple natural gas fired furnaces comprises capturing air with high speed blower units in the furnaces, pressing the air through heat transfer chambers in the furnaces to heat up the captured air, and discharging the heated air into the treatment chamber.

The step 216 of circulating heat through the insulated treatment chamber using multiple ductworks comprises connecting multiple insulated intake ducts and exhaust ducts to multiple intake vents and exhaust vents evenly along lower, middle, and upper wall sections of the insulated treatment chamber, discharging the heated air from the furnaces into the treatment chamber, pushing the heated air through the suspended bagged food products on the racking system and out of the exhaust vents and exhaust ducts back to the furnaces. In the preferred method, this step may further comprise a step 217 of providing three sets of intake ducts and three sets of exhaust ducts on opposite walls of the treatment chamber, wherein each set of intake ducts comprises an upper intake duct connected to three upper intake vents, a middle intake duct connected to three middle intake vents, and a lower intake duct connected to three lower intake vents, and wherein each set of exhaust ducts comprises an upper exhaust duct connected to three upper exhaust vents, a middle exhaust duct connected to three middle exhaust vents, and a lower intake duct connected to three lower exhaust vents.

The step 218 of monitoring temperatures in the insulated treatment chamber, the multiple natural gas fired furnaces, and the bagged food products simultaneously further comprises providing multiple temperature sensor probes in the treatment chamber, the gas fired furnaces, and the bagged food product and providing a computer program to monitor the temperature of each temperature sensor probe. In a preferred method, when the temperature sensor probes inside the middle of the bags read that a certain predetermined temperature has been reached and remains at that temperature for a period of time, the computer program notifies an electronic panel controlling the furnaces to automatically shut down and engage the cooling system to rapidly cool the bags to prevent condensation and moisture build up inside the bag. Subsequently, the temperatures inside randomly selected bags are taken to validate the accuracy of the thermal couple sensors and the temperature inside the bags.

According to the preferred method, after the process is complete, samples are taken of the treated bagged food products 20 and submitted to independent third-party laboratories for confirmation analysis. In particular, the samples are tested for total plate count (TPC), E. coli count, Staphylococcus Aureus, salmonella, listeria (Rapid), yeast count, mold count, and moisture. The typical results obtained of the treated food products using the heating assembly 10 and/or the method 200 reveal TPC of under 1,000, and in most cases around 300 or lower, as opposed to the TPC of untreated products, which can be as high as 50,000 or more. In addition, Coliform, E. coli, Staphylococcus Aureus, salmonella, and listeria are typically less than 100, and in most cases less than 10 and/or negative; yeast, and mold counts are typically less than 100; and moisture in the treated products is typically around 5%, as opposed to moisture found in untreated products, which is typically around 10 or 11%.

While the samples are being tested by the third-party laboratories, the rest of the treated bagged food products are set aside with a label “test pending.” After the results of the third-party tests are confirmed, the batch of the treated bagged food products are taken out of the “test pending” status, marked with a label identifying the date of treatment, product name, and product lot number, and placed into the warehouse inventory for storage or further shipment.

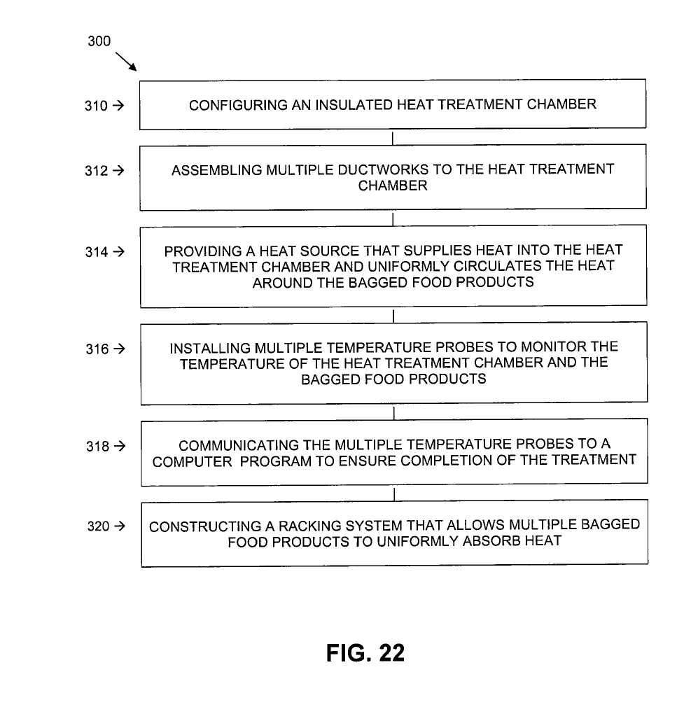

FIG. 22 illustrates a preferred method 300 of assembling a heat treatment assembly for reducing foodborne pathogens in bagged food products using heat treatment. The method 300 comprises a step 310 of configuring an insulated heat treatment chamber, a step 312 of assembling multiple ductworks to the heat treatment chamber, a step 314 of providing a heat source that supplies heat into the heat treatment chamber and uniformly circulates the heat around the bagged food products, a step 316 of installing multiple temperature probes to monitor the temperature of the heat treatment chamber and the bagged food products, a step 318 of communicating the multiple temperature probes to a computer program to ensure completion of the treatment, and a step 320 of constructing a racking system that allows multiple bagged food products to uniformly absorb heat.

The step 310 of configuring an insulated heat treatment chamber comprises constructing an elongated chamber wherein the chamber's walls, floor and ceiling are insulated with high temperature heat resistant insulation material encased in stainless steel liner, and wherein one side wall comprises multiple intake vents configured to receive insulated intake ducts and a corresponding opposite side wall comprises multiple exhaust vents configured to receive insulated exhaust ducts. According to one method, the heat treatment chamber is further divided into multiple heating zones. In the preferred method, the heat treatment chamber is further divided into three sections of heating zones, wherein each heating zone comprises multiple intake vents on one side wall and corresponding multiple exhaust vents on the opposite side wall.

The step 312 of assembling multiple ductworks to the heat treatment chamber comprises installing multiple intake ducts on the exterior of one side wall of the heat treatment chamber and multiple exhaust ducts on the exterior of the opposite side wall of the heat treatment chamber. According to a preferred method, three sets of multiple intake ducts are installed on the exterior of one side wall of the heat treatment chamber and three sets of multiple exhaust ducts are installed on the exterior of the corresponding opposite side wall of the treatment chamber, wherein each set of intake duct further comprises an upper intake duct, a middle intake duct and a lower intake duct, and each set of exhaust duct further comprises an upper exhaust duct, a middle exhaust duct and a lower exhaust duct.

The step 314 of providing a heat source that supplies heat into the heat treatment chamber and uniformly circulates the heat around the bagged food products comprises connecting multiple natural gas fired furnaces to the multiple ductworks, namely the multiple intake ducts and the multiple exhaust ducts, wherein the furnaces capture the air, heat the air inside a fire box of each furnace, and push the heated air using a blower fan installed within each furnace through the multiple ductworks, around the bagged food products inside the chamber, and back to the furnaces.

The step 316 of installing multiple temperature probes to monitor the temperature of the heat treatment chamber and the bagged food products further comprises placing a plurality of chamber thermocouple sensors on the interior of the side wall and placing a plurality of food product thermocouple sensors in even spacing along the interior of both side walls, wherein the food product thermocouple sensors further penetrate the bags containing the food products.

The step 318 of communicating the multiple temperature probes to a computer program to ensure completion of the treatment further comprises interactively interfacing the chamber thermocouple sensors and the food product thermocouple sensors to a thermocouple control panel, a main electrical control panel, and a computer program to allow exchange of data and information in real time regarding temperatures of the furnaces, the treatment chamber, the bagged food products, gas pressure and process timing. In a preferred method, the thermocouples record the temperature changes in the treatment chamber, the fire boxes, and the bagged food products, send the information to the computer program, and the computer program registers a real time reading of the temperatures. When the computer program shows that the food product thermocouples have reached a desired temperature for a certain period of time, preferably 170° F. for one hour, the computer program automatically begins to shut down the heating assembly.

The step 320 of constructing a racking system that allows multiple bagged food products to uniformly absorb heat further comprises connecting four upper horizontal beams and four lower horizontal beams to four elongated vertical beams that are longer in length than the horizontal beams at their respective ends so as to form an upright rectangular cuboid, placing a plurality of wire shelves along the vertical beams, and configuring four wheels on the bottom corners of the racking assembly.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what incorporates the essential idea of the invention.

What is claimed is:

1. A method of reducing foodborne pathogens in bagged food products using heat treatment comprising:
providing an insulated heat treatment chamber;
placing the bagged food products in the insulated heat treatment chamber;
supplying heat to the insulated treatment chamber using multiple natural gas fired furnaces;
circulating heat through the insulated treatment chamber using multiple ductworks; and
monitoring temperatures in the insulated treatment chamber, the multiple natural gas fired furnaces, and the bagged food products simultaneously.

2. The method of claim 1, wherein the step of providing an insulated heat treatment chamber comprises providing a self-contained unit connected to a building, wherein the floor, walls, and ceiling of the unit are insulated by high heat resistant material encapsulated in a stainless steel liner.

3. The method of claim 1, wherein the step of placing the bagged food products in an insulated treatment chamber further comprises providing a racking system with multiple levels that suspends the bagged food products on the racking system such that air circulates on top, bottom, and sides of each bag.

4. The method of claim 1, wherein the step of supplying heat to the insulated treatment chamber using multiple natural gas fired furnaces further comprises capturing air with high speed blower units in the furnaces, pressing the air through heat transfer chambers in the furnaces to heat up the captured air, and discharging the heated air into the treatment chamber.

5. The method of claim 1, wherein the step of circulating heat through the insulated treatment chamber using multiple ductworks further comprises connecting multiple insulated intake ducts and exhaust ducts to multiple intake vents and exhaust vents evenly along lower, middle, and upper wall sections of the insulated treatment chamber, discharging the heated air from the furnaces into the treatment chamber, pushing the heated air through the suspended bagged food products on the racking system and out of the exhaust vents and exhaust ducts back to the furnaces.

6. The method of claim 5, further comprising a step of providing three sets of intake ducts and three sets of exhaust ducts on opposite walls of the treatment chamber, wherein each set of intake ducts comprises an upper intake duct connected to three upper intake vents, a middle intake duct connected to three middle intake vents, and a lower intake duct connected to three lower intake vents, and wherein each set of exhaust ducts comprises an upper exhaust duct connected to three upper exhaust vents, a middle exhaust duct connected to three middle exhaust vents, and a lower intake duct connected to three lower exhaust vents.

7. The method of claim 1, wherein the step of monitoring temperatures in the insulated treatment chamber, the multiple natural gas fired furnaces, and the bagged food products simultaneously further comprises providing multiple temperature sensor probes in the treatment chamber, the gas fired furnaces, and the bagged food products and providing a computer program to monitor the temperature of each temperature sensor probe.

8. The method of claim 7, further comprising engaging the computer program to notify an electronic panel controlling the multiple natural gas fired furnaces to automatically shut down and begin a rapid cooling process when the temperature inside the bagged food products reach a predetermined temperature for a period of time.

9. A method of processing food products containing reduced foodborne pathogens for storage and shipment, comprising:
processing bagged food products for thermal treatment;
placing the bagged food products in an insulated treatment chamber;
supplying heat to the insulated treatment chamber using multiple natural gas fired furnaces;
circulating heat through the insulated treatment chamber using multiple ductworks;
monitoring temperatures in the insulated treatment chamber, the multiple natural gas fired furnaces, and the bagged food products simultaneously;
providing a rapid automatic cooling process; and
preparing thermal treated bagged food products for warehouse storage and shipment.

10. The method of claim 9, wherein the step of placing the bagged food products in an insulated treatment chamber further comprises providing a racking system with multiple levels that suspends the bagged food products on the racking system such that air circulates on top, bottom, and sides of each bag.

11. The method of claim 9, wherein the step of supplying heat to the insulated treatment chamber using multiple natural gas fired furnaces further comprises capturing air with high speed blower units in the furnaces, pressing the air through heat transfer chambers in the furnaces to heat up the captured air, and discharging the heated air to the multiple ductworks.

12. The method of claim 9, wherein the step of circulating heat through the insulated treatment chamber using multiple ductworks further comprises connecting multiple insulated intake ducts and exhaust ducts to multiple intake vents and exhaust vents evenly along lower, middle, and upper wall sections of the insulated treatment chamber, discharging the heated air from the furnaces into the treatment chamber, pushing the heated air through the suspended bagged food products on the racking system and out of the exhaust vents and exhaust ducts back to the furnaces.

13. The method of claim 9, further comprising a step of providing three sets of intake ducts and three sets of exhaust ducts on opposite walls of the treatment chamber, wherein each set of intake ducts comprises an upper intake duct connected to three upper intake vents, a middle intake duct connected to three middle intake vents, and a lower intake duct connected to three lower intake vents, and wherein each set of exhaust ducts comprises an upper exhaust duct connected to three upper exhaust vents, a middle exhaust duct connected to three middle exhaust vents, and a lower intake duct connected to three lower exhaust vents.

14. A method of assembling a heat treatment assembly for reducing foodborne pathogens in bagged food products using heat treatment, comprising:
configuring an insulated heat treatment chamber;
assembling multiple ductworks to the heat treatment chamber;
providing a heat source that supplies heat into the heat treatment chamber and uniformly circulates the heat around the bagged food products;
installing multiple temperature probes to monitor the temperature of the heat treatment chamber and the bagged food products;
communicating the multiple temperature probes to a computer program to ensure completion of the treatment; and
constructing a racking system that allows multiple bagged food products to uniformly absorb heat.

15. The method of claim 14, wherein the step of configuring an insulated heat treatment chamber further comprises constructing an elongated chamber wherein the chamber's walls, floor and ceiling are insulated with high temperature heat resistant insulation material encased in stainless steel liner, and wherein one side wall comprises multiple intake vents configured to receive insulated intake ducts and a corresponding opposite side wall comprises multiple exhaust vents configured to receive insulated exhaust ducts.

16. The method of claim 14, wherein the step of assembling multiple ductworks to the heat treatment chamber further comprises installing multiple intake ducts on the exterior of one side wall of the heat treatment chamber and multiple exhaust ducts on the exterior of the opposite side wall of the heat treatment chamber.

17. The method of claim 14, wherein the step of providing a heat source that supplies heat into the heat treatment chamber and uniformly circulates the heat around the bagged food products comprises connecting multiple natural gas fired furnaces to the multiple ductworks, wherein the furnaces capture the air, heat the air inside a fire box of each furnace, and push the heated air using a blower fan installed within each furnace through the multiple ductworks, around the bagged food products inside the chamber, and back to the furnaces.

18. The method of claim 14, wherein the step of installing multiple temperature probes to monitor the temperature of the heat treatment chamber and the bagged food products further comprises placing a plurality of chamber thermocouple sensors on the interior of the side wall and placing a plurality of food product thermocouple sensors in even spacing along the interior of both side walls, wherein the food product thermocouple sensors further penetrate the bags containing the food products.

19. The method of claim 14, wherein the step of communicating the multiple temperature probes to a computer program to ensure completion of the treatment further comprises interactively interfacing the chamber thermocouple sensors and the food product thermocouple sensors to a thermocouple control panel, a main electrical control panel, and a computer program to allow exchange of data and information in real time regarding temperatures of the furnaces, the treatment chamber, the bagged food products, gas pressure and process timing.

20. The method of claim 14, wherein the step of constructing a racking system that allows multiple bagged food products to uniformly absorb heat further comprises connecting four upper horizontal beams and four lower horizontal beams to four elongated vertical beams that are longer in length than the horizontal beams at their respective ends so as to form an upright rectangular cuboid, placing a plurality of wire shelves along the vertical beams, and configuring four wheels on the bottom corners of the racking assembly.
